(19) United States
(12) Patent Application Publication
(10) Pub. No.: US 2015/0346947 A1
(43) Pub. Date: Dec. 3, 2015

(54) FEEDBACK IN TOUCHLESS USER INTERFACE

(71) Applicant: CRUNCHFISH AB, Malmö (SE)

(72) Inventor: Joachim SAMUELSSON, Helsingborg (SE)

(73) Assignee: CRUNCHFISH AB, Malmö (SE)

(21) Appl. No.: 14/761,825

(22) PCT Filed: Jan. 22, 2014
(86) PCT No.: PCT/SE2014/050071

§ 371 Date: Jul. 17, 2015

(30) Foreign Application Priority Data
Jan. 22, 2013 (SE) 1350065-7

(51) Int. Cl. G06F 3/0481; G06F 3/0484; G06F 3/01

(52) U.S. Cl. CPC G06F 3/04812; G06F 3/017; G06F 3/04842

(57) ABSTRACT

A computing device (100, 200) comprising a display (120) and a controller (210), wherein said controller (210) is configured to detect and track an object (H) via a video stream (265) provided by a camera (160, 260), and indicate an operating area on the display (120) which is currently open for manipulation by the tracked object (H) by changing displaying properties, of a marker area (170) on the display (120). Wherein the controller detects that a tracked object is moved in a direction substantially perpendicular to the plane of the display and in response thereto adapt the marker area and/or the extension of the marker area.

### TECHNICAL FIELD

This application relates to a method, a computer-readable medium and a device for providing visual feedback, and in particular to a method, a computer-readable medium and a device for providing visual feedback in a touchless user interface.

### BACKGROUND

Developers of graphical interfaces have been using a marker, such as an arrow, for a long time to indicate to a user where on a display the user is currently operating through the use of a mouse or other similar input means. The use of such a marker intuitively couples the position of the mouse to the displayed content. However, the marker will also be present at all times and will clutter the display and potentially hide or obscure some of the displayed content. One solution is to hide the marker after a period of inactivity.

A disadvantage is that the marker area can be difficult to discern, especially if it has the same color as the underlying displayed content. The marker may also, as stated above, hide or obscure displayed content.

Especially in touchless user interfaces it is important to provide an intuitive visual feedback to t user to enable for a cognitive coupling between any gesture made and the resulting action taken or to be taken. If no visual feedback is presented the user will not be able to tell if the device is actively receiving control information or not until an action is actually executed.

There is thus a need for an improved manner of providing visual feedback to a user of a current operating area, especially in a touchless user interface where a marker's movements to accommodate for a user's changed input position will be confusing to a user or bewildering as described above.

### SUMMARY

It is an object of the teachings of this application to overcome the problems listed above by providing a computing device comprising a display and a controller, wherein said controller is configured to detect and track an object via a video stream provided by a camera, and indicate an operating area on the display which is currently open for manipulation by the tracked object by changing displaying properties of a marker area on the display.

In one embodiment the controller is further configured to indicate the operating area by only changing the displaying properties of the marker area.

Such a computing device enables for an improved visual feedback to a user in that the displayed content or the display is not cluttered, obscured or hid.

In one embodiment the displaying properties is the color, contrast and/or brightness of the marker area.

In one embodiment the marker area has an extension and the controller is further configured to detect that the tracked object is moved in a direction substantially perpendicular to the plane of the display and in response thereto adapt the marker area, by further increasing the displaying properties of the marker area and/or the extension of the marker area.

In one embodiment, the computing device is a mobile communications terminal. In one embodiment, the computing device is a tablet computer or a laptop computer. In one embodiment, the computing device is a game console. In one embodiment, the computing device is a media device such as a television set or media system.

It is also an object of the teachings of this application to overcome the problems listed above by providing a method for use in a computing device comprising a display, said method comprises detecting and tracking an object via a video stream provided by a camera, and indicating an operating area on the display which is currently open for manipulation by the tracked object by changing displaying properties of a marker area on the display.

It is a further object of the teachings of this application to overcome the problems listed above by providing a computer readable medium comprising instructions that when loaded into and executed by a controller, such as a processor, cause the execution of a method according to herein.

The inventors of the present invention have realized, after inventive and insightful reasoning that by (only) changing the display properties of a marker area there is no need to display a cursor or other visual object indicating a current operating area which may obstruct, hide or clutter displayed content on a display. The displaying properties are changed in a manner to increase their visibility, not necessarily the discernibliness of objects within the marker area, so that the position can be easily discernible and spotted by a user so that the user is made aware of where the operating area currently is. In one embodiment the displaying properties of the marker area are changed so that the original display content of the marker area is modified or thwarted to further increase the marker area's discernibliness.

Furthermore, in a touchless user interface a user continuously moves his hand inside and outside the camera view, much as a user moves his hand to the keypad and away from the keypad. A marker that is to indicate the position of a tracked object will then be jumping around on the display which will be confusing to a user. A user will perceive a soft, but discernible, change in the displaying properties such as changed contrast, brightness or color as less confusing in that it provides a softer change of the displayed content in contrast to the abrupt appearance of a new object—the marker.

The teachings herein find use in control systems for devices having user interfaces such as mobile phones, smart phones, tablet computers, computers (portable and stationary), gaming consoles and media and other infotainment devices.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

FIGS. 1A, 1B and 1C are schematic views of each a computing device according to the teachings herein;

FIG. 2 is a schematic view of the components of a computing device according to the teachings herein;

FIG. 3 is a schematic view of a computer-readable memory according to the teachings herein;

FIGS. 4A and 4B show an example embodiment according to the teachings herein; and

FIG. 5 shows a flowchart illustrating a general method according to an embodiment of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

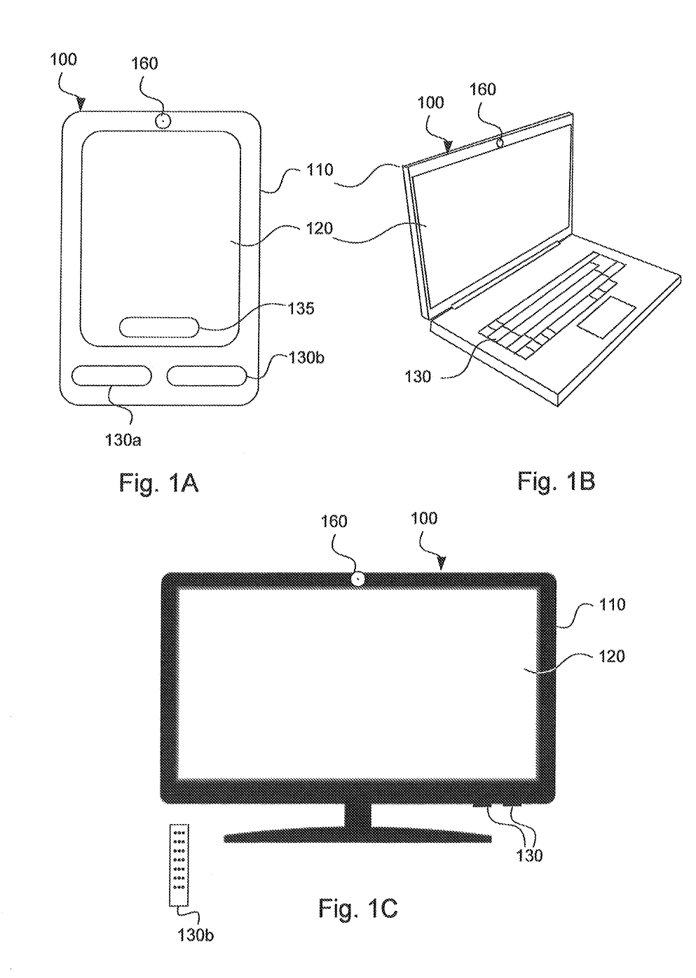

FIG. 1 generally shows a computing device 100 according to an embodiment herein. In one embodiment the computing device 100 is configured for network communication, either wireless or wired. Examples of a computing device 100 are: a personal computer, desktop or laptop, a tablet computer, a mobile communications terminal such as a mobile telephone, a smart phone, a personal digital assistant and a game console. Three embodiments will be exemplified and described as being a smartphone in FIG. 1A, a laptop computer 100 in FIG. 1B as an example of a computer and a TV 100 in FIG. 1C as an example of a media device. A media device is considered to be a computing device in the context of this application in the aspect that it is configured to receive digital content, process or compute the content and present the resulting or computed media, such as image(s) and/or audio.

Referring to FIG. 1A a mobile communications terminal in the form of a smartphone 100 comprises a housing 110 in which a display 120 is arranged. In one embodiment the display 120 is a touch display. In other embodiments the display 120 is a non-touch display. Furthermore, the smartphone 100 comprises two keys 130a, 130b. In this embodiment there are two keys 130, but any number of keys is possible and depends on the design of the smartphone 100. In one embodiment the smartphone 100 is configured to display and operate a virtual key 135 on the touch display 120. It should be noted that the number of virtual keys 135 are dependant on the design of the smartphone 100 and an application that is executed on the smartphone 100. The smartphone 100 is also equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1B a laptop computer 100 comprises a display 120 and a housing 110. The housing comprises a controller or CPU (not shown) and one or more computer-readable storage mediums (not shown), such as storage units and internal memory. Examples of storage units are disk drives or hard drives. The laptop computer 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable a laptop computer 100 to connect with other computing devices or a server.

The laptop computer 100 further comprises at least one input unit such as a keyboard 130. Other examples of input units are computer mouse, touch pads, touch screens or joysticks to name a few.

The laptop computer 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

Referring to FIG. 1C a media device, such as a television set, TV, 100 comprises a display 120 and a housing 110. The housing comprises a controller or CPU (not shown) and one or more computer-readable storage mediums (not shown), such as storage units and internal memory, for storing user settings and control software. The computing device 100 may further comprise at least one data port (not shown). Data ports can be wired and/or wireless. Examples of data ports are USB (Universal Serial Bus) ports, Ethernet ports or WiFi (according to IEEE standard 802.11) ports. Such data ports are configured to enable the TV 100 to connect with an external storage medium, such as a USB stick, or to connect with other computing devices or a server.

The TV 100 may further comprise an input unit such as at least one key 130 or a remote control 130b for operating the TV 100.

The TV 100 is further equipped with a camera 160. The camera 160 is a digital camera that is arranged to take video or still photographs by recording images on an electronic image sensor (not shown). In one embodiment the camera 160 is an external camera. In one embodiment the camera is alternatively replaced by a source providing an image stream.

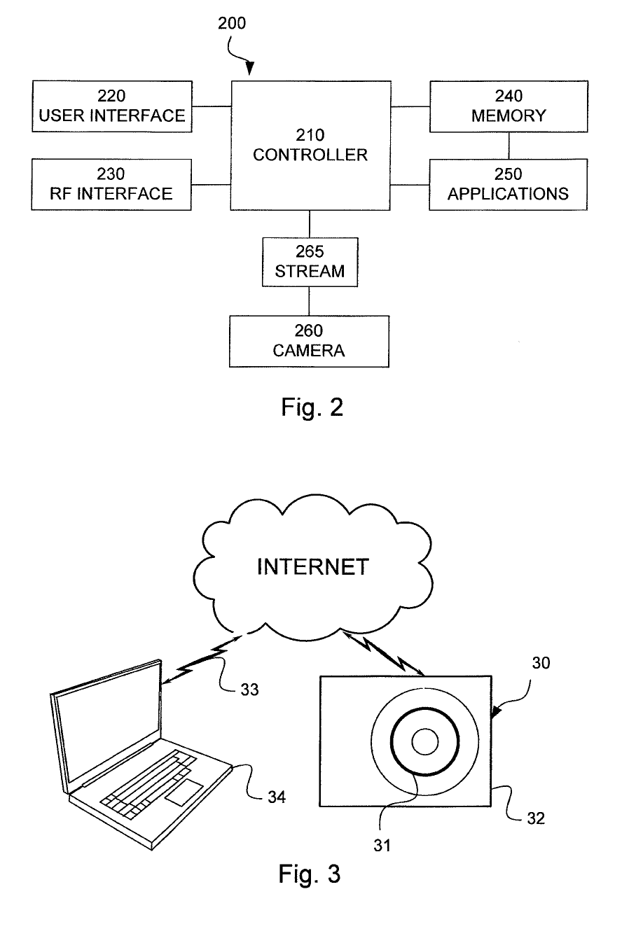

FIG. 2 shows a schematic view of the general structure of a device according to FIG. 1. The device 100 comprises a controller 210 which is responsible for the overall operation of the computing device 200 and is preferably implemented by any commercially available CPU (“Central Processing Unit”), DSP (“Digital Signal Processor”) or any other electronic programmable logic device. The controller 210 is configured to read instructions from the memory 240 and execute these instructions to control the operation of the computing device 100. The memory 240 may be implemented using any commonly known technology for computer-readable memories such as ROM, RAM, SRAM, DRAM, CMOS, FLASH, DDR, SDRAM or some other memory technology. The memory 240 is used for various purposes by the controller 210, one of them being for storing application data and program instructions 250 for various software modules in the computing device 200. The software modules include a real-time operating system, drivers for a user interface 220, an application handler as well as various applications 250.

The computing device 200 further comprises a user interface 220, which in the computing device of FIGS. 1A, 1B and 1C is comprised of the display 120 and the keys 130, 135.

The computing device 200 may further comprises a radio frequency interface 230, which is adapted to allow the computing device to communicate with other devices through a radio frequency band through the use of different radio frequency technologies. Examples of such technologies are IEEE 802.11, IEEE 802.15, ZigBee, WirelessHART, WIFI, Bluetooth®, W-CDMA/HSPA, GSM, UTRAN and LTE to name a few.

The computing device 200 is further equipped with a camera 260. The camera 260 is a digital camera that is arranged to take video or still photographs by recording images on an electronic image sensor (not shown).

The camera 260 is operably connected to the controller 210 to provide the controller with a video stream 265, i.e. the series of images captured, for further processing possibly for use in and/or according to one or several of the applications 250.

In one embodiment the camera 260 is an external camera or source of an image stream.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 3 shows a schematic view of a computer-readable medium as described in the above. The computer-readable medium 30 is in this embodiment a data disc 30. In one embodiment the data disc 30 is a magnetic data storage disc. The data disc 30 is configured to carry instructions 31 that when loaded into a controller, such as a processor, executes a method or procedure according to the embodiments disclosed above. The data disc 30 is arranged to be connected to or within and read by a reading device 32, for loading the instructions into the controller. One such example of a reading device 32 in combination with one (or several) data disc(s) 30 is a hard drive. It should be noted that the computer-readable medium can also be other mediums such as compact discs, digital video discs, flash memories or other memory technologies commonly used.

The instructions 31 may also be downloaded to a computer data reading device 34, such as a laptop computer or other device capable of reading computer coded data on a computer-readable medium, by comprising the instructions 31 in a computer-readable signal 33 which is transmitted via a wireless (or wired) interface (for example via the Internet) to the computer data reading device 34 for loading the instructions 31 into a controller. In such an embodiment the computer-readable signal 33 is one type of a computer-readable medium 30.

The instructions may be stored in a memory (not shown explicitly in FIG. 3, but referenced 240 in FIG. 2) of the laptop computer 34.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

An improved manner of providing visual feedback when tracking an object will be disclosed below with reference to the accompanying figures. The examples will be illustrated focusing on resulting visual feedback, but it should be clear that the processing is performed in part or fully in a computing device comprising a controller as disclosed above with reference to FIGS. 1 and 2 or caused to be performed by executing instructions stored on a computer-readable medium as disclosed with reference to FIG. 3.

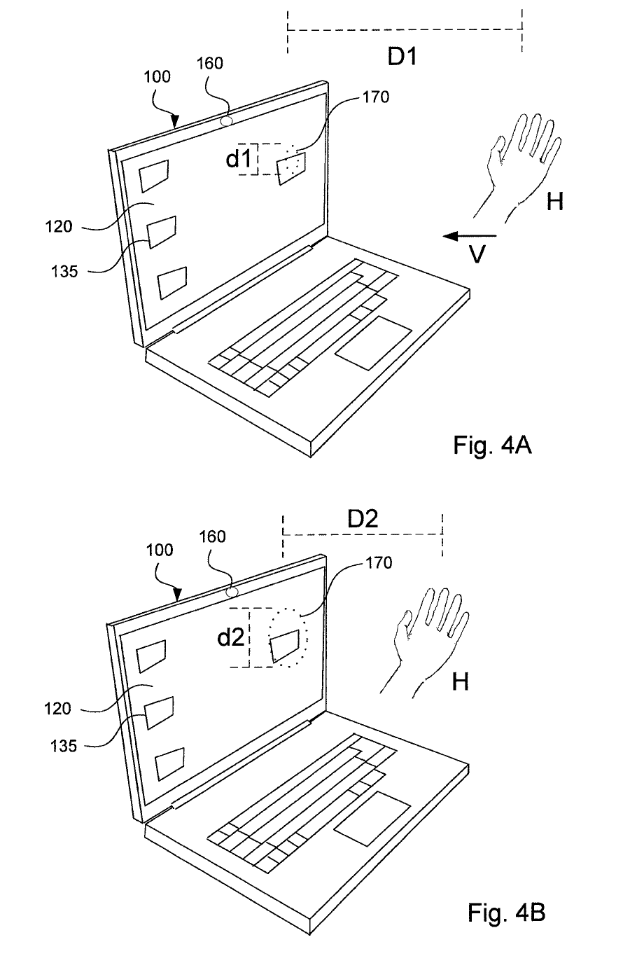

FIG. 4A shows an example computing device such as in FIG. 1, in this example a laptop computer 100 such as the laptop computer 100 of FIG. 1B, configured to detect and track an object, in this example a hand H, via the camera 160. How such an object H is detected and tracked is disclosed in the Swedish patent application SE 1250910-5 and will not be discussed in further detail in the present application. For further details on this, please see the mentioned Swedish patent application. It should be noted, however, that the teachings of the present application may be implemented through the use of other tracking manners than disclosed in Swedish patent application SE 1250910-5.

The laptop computer is displaying a number of object 135 arranged to be manipulated on the display 120. To enable a user to understand how his actions and movements relating to the tracked hand H manipulates the displayed objects 135 the laptop computer 100 is configured to indicate a current position on the display which is currently open for manipulation by the hand H—an operating area—by changing the displaying properties of a marker area 170 on the display 120. The displaying properties that may be changed are the color, contrast and/or brightness.

This allows a user to clearly see where on the display 120 he is currently operating without the need for a cursor or other displayed object which may clutter the display 120 and hide, obscure or conceal underlying content. This is a problem especially in devices with relatively small screen such as smart phones and tablet computers.

The laptop computer 100 is thus configured to indicate an operating area by only changing the displaying properties in a marker area 170.

The marker area 170 has an extension d1. The exact measurement of the extension depends on the user interface design and other parameters. In the example of FIG. 1 the extension is circular (shown elliptical due to the viewing angel). Typically the extension of the marker area 170 is initially 1 to 5 pixels in diameter, depending on display size and/or display resolution. The extension d1 of the marker area 170 is small to avoid distorting the displayed content to a disturbing degree.

In on embodiment the extension of the marker area 170 equals the area which a user may manipulate and any manipulation effected by a user results in a manipulation of any and all objects within the marker area 170.

In one embodiment the center of the marker area 170 indicates the area which a user may manipulate and any manipulation effected by a user results in a manipulation of an objects at or adjacent to the center of the marker area 170.

To enable the user to more clearly see which area he is currently operating within the laptop computer 100 is configured to detect that the tracked object, the hand H, is moved in a direction substantially perpendicular to the plane of the display 120 that is towards the display 120. Details on how such Z-axis detection may be implemented are disclosed in the Swedish patent application SE 1250910-5 and will not be discussed in further detail in the present application. For further details on this, please see the mentioned Swedish patent application. It should be noted, however, that the teachings of the present application may be implemented through the use of other tracking manners than disclosed in Swedish patent application SE 1250910-5.

As the laptop computer 100 detects a movement towards the display 120 of the tracked object H, the laptop computer 100 is configured to adapt the marker area 170.

The marker area 170 may be adapted by further changing the displaying properties by further increasing the contrast and/or brightness of the marker area 170 or by further changing the color of the marker area 170.

The marker area 170 may be adapted by further changing the displaying properties by further increasing the extension of the marker area 170. As is shown in FIG. 4B, the hand H has moved from a distance D1 to a distance D2 from the display 120 and the marker area 170 has been adapted to an increased extension d2.

The extension d1, d2 and/or displaying properties of the marker area 170 may be dependent on the distance D1, D2 of the tracked object H to the display 120. The dependency may be linear or stepwise. In an embodiment where the extension d1, d2 and/or displaying properties are stepwise dependent on the distance D1, D2 the laptop computer 100 is configured to adapt the extension d1, d2 and/or displaying properties (incrementally) as the distance D1, D2 changes below or above at least a first threshold distance.

In one embodiment the laptop computer 100 is configured to adapt the marker area increasingly as the distance D1, D2 is reduced (D1 to D2). This allows for a user to more clearly focus on the area to be controlled and more clearly determine what action may be taken.

In one embodiment the laptop computer 100 is configured to adapt the marker area 170 increasingly as the distance D1, D2 is increased (D2 to D1). This allows for a user to more clearly see marker area 170 when at a distance, should the tracked movement be a result of the user moving. In such an embodiment the laptop computer 100 is further configured to detect a user, possibly through detecting a face (not shown), in the vicinity of the tracked object H and determine if a distance to the face changes in the same manner as the distance D1, D2 to the tracked object H, which would be indicative of a user simply moving.

The marker area 170 may be adapted by further changing the displaying properties by further increasing the contrast and/or brightness in combination with increasing the extension.

It should be noted that the distance D1, D2 should be understood to not be limited to the distance between the tracked object H and the display 120, but may also be a distance between the tracked object H and the camera 160.

In one embodiment the absolute value of the distance D1, D2 is not decisive for the extension d1, d2 or the changed displaying properties of the marker area 170. In such an embodiment it is the change in distance D1-D2 that is decisive.

In one embodiment the laptop computer 100 is configured to detect a tracked object H and in response thereto indicate a marker area 170 at an initial position and/or an initial extension. The initial position may be the middle of the display 120. The initial position may alternatively be in a corner of the display 120. This allows a user to always start in the same position which enables the user to find the marker area 170 in a simple manner. The initial extension may be based on a detected distance or it may be a fixed initial extension, such as discussed in the above with relation to the first extension d1.

In one embodiment the laptop computer 100 is configured to detect a speed V (indicated in FIG. 4A with a speed vector V) of the tracked object H and determine whether the detected speed V is above a speed threshold and, if so, determine that the tracked movement is an event relating to an object 135 to be manipulated, such as a select event or activate event. And, if the detected speed V is below the speed threshold determine that the marker area 170 should be adapted.

When estimating the velocity in a Z direction the controller may use the change in Z direction as disclosed in the Swedish patent application SE 1250910-5. The change in z direction is measured by estimating the change in changes of the X and Y positions of the keypoints between two image frames, that is delta x and delta y. We then plot the delta x and delta y and fit a straight line between the plots. The slope of this line gives a measurement of the change in Z direction. By dividing the time taken between handling two consecutive image frames (by using 1/framerate as delta time) a measurement of the velocity in the z direction is provided.

The measurement may be chosen to represent a speed of 5 cm/s, 10 cm/s, 20 cm/s, or faster (or slower) to differentiate between a fast movement and a slow movement.

In one embodiment the laptop computer 100 is configured to detect if the speed V of the tracked object H and determine whether the detected speed V is above a speed threshold and whether the movement is away from the display 120, the speed V is negative, and, if so, discontinue the tracking of the tracked object H and discontinue the indication of the current position on the display which is currently open for manipulation by the tracked object H.

The user may begin manipulation again by, for example, raising his hand H which is then detected by the laptop computer 100 which indicates the marker area 170, possibly at an initial position and at an initial size.

In one embodiment the laptop computer 100 is configured to determine if the marker area 170 coincides (at least partially) with a displayed object 135 and if the distance D1, D2 between the tracked object H and the displayed object 135 (or display 120) is below a second threshold and if so display an option menu associated with the displayed object 135. As would be understood by a skilled person the distance threshold depends on the computing device and the display size. As would be apparent to a skilled person the exact distances and also the distance threshold is dependant to a large extent on features such as the display size, the camera viewing angle, the angle of the camera with regards to the display and to provide distance thresholds suitable for all possible combinations would constitute an exhaustive work effort and not provide for a higher understanding of the manners taught herein. An example of a distance threshold is a distance of 10 cm.

In one example, the displayed object 120 may relate to a media player application and the associated option menu may comprise controls for playing/pausing, skipping forwards/backwards and also possibly volume control, opening a (media) file etc.

In one embodiment the laptop computer 100 is configured to adapt an input interpretation scale based on the distance D1, D2 to the tracked object. The input interpretation scale determines how the tracked movement should correlate to the movement of the marker area 170. This allows for a user to control the accuracy of an input by moving his hand away from the display 120, thereby enabling for larger movements of the tracked object resulting in smaller movements of the marker area 170 to result in an increased accuracy as larger movements are easier to control and differentiate.

By configuring the laptop computer 100 to adapt the input interpretation scale non-linearly, either continuously or stepwise, the accuracy is further increased.

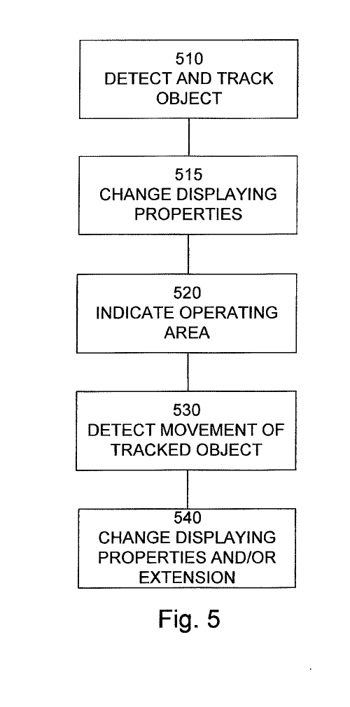

FIG. 5 shows a flowchart of a general method according to the teachings herein. A computing device detects and tracks 510 an object, such as a hand, and possibly assigns an initial position of a marker area which indicates an operating area. The computing device changes the displaying properties 515 of the marker area and thereby visually indicates the operating area 520 to a user who is able to discern the marker area as it differs from the surrounding displayed content in that for example the contrast and/or brightness is different in the marker area.

When the computing device detects a movement in a direction perpendicular to the display plane (that is towards or away from the display) the displaying properties and/or the extension of the marker area is further changed 540. This allows for a user to more easily discern the marker are and therefore better control any manipulation to be made in the operating area.

The teachings herein provide the benefit that a user is provided with a visual feedback that is easily discernible and which does not clutter, hide, obscure or conceal displayed content.

Another benefit lies in that a user is able to vary the feedback and possibly control region in a simple manner.

The invention has mainly been described above with reference to a few embodiments. However, as is readily appreciated by a person skilled in the art, other embodiments than the ones disclosed above are equally possible within the scope of the invention, as defined by the appended patent claims.

1. A computing device (100, 200) comprising a display (120) and a controller (210), wherein said controller (210) is configured to:
detect and track an object (H) via a video stream (265) provided by a camera (160, 260); and
indicate an operating area on the display (120) which is currently open for manipulation by the tracked object (H) by changing displaying properties of a marker area (170) on the display (120), wherein said displaying properties is the color, contrast and/or brightness of the marker area (170), and
wherein the marker area (170) has an extension (d1, d2) and
wherein said controller (210) is further configured to detect that the tracked object (H) is moved in a direction substantially perpendicular to the plane of the display (120) and in response thereto adapt the marker area (170), by further increasing the displaying properties of the marker area (170) and/or the extension (d1, d2) of the marker area (170), thereby providing visual feedback to a user of a current operating area.

2. The computing device (100, 200) according to claim 1, wherein said controller (210) is further configured to indicate the operating area by only changing the displaying properties of the marker area (170).

3. The computing device (100, 200) according to claim 1, wherein the extension (d1, d2) of the marker area (170) substantially equals the operating area any manipulation effected by a user results in a manipulation of any and all objects (135) within the marker area (170).

4. The computing device (100, 200) according to claim 1, wherein a center of the marker area (170) indicates the area which a user may manipulate and any manipulation effected by a user results in a manipulation of an objects at or adjacent to the center of the marker area (170).

5. The computing device (100, 200) according to claim 1, wherein said controller (210) is further configured to adapt the marker area (170) increasingly as a distance (D1, D2) between the tracked object (H) and the display (120) is increased.

6. The computing device (100, 200) according to claim 5, wherein said controller (210) is further configured to detect a face in the vicinity of the tracked object (H) and determine if a distance to the face changes in the same manner as the distance (D1, D2) between the tracked object (H) and the display (120) and if so adapt the marker area (170) increasingly as a distance (D1, D2) between the tracked object (H) and the display (120) is increased.

7. The computing device (100, 200) according to claim 1, wherein said controller (210) is further configured to adapt the marker area (170) with respect to a distance (D1, D2) linearly.

8. The computing device (100, 200) according to claim 1, wherein said controller (210) is further configured to adapt the marker area (170) with respect to a distance (D1, D2) stepwise.

9. The computing device (100, 200) according to claim 1, wherein said controller (210) is further configured to indicate a marker area 170 at an initial position and/or an initial extension in response to detecting said tracked object (H).

10. The computing device (100, 200) according to claim 1, wherein said controller (210) is further configured to detect a speed (V) of the tracked object (H) and determine whether the detected speed (V) is above a speed threshold and, if so, determine that the tracked movement is an event relating to an object (135) to be manipulated, and, if the detected speed (V) is below the speed threshold determine that the marker area (170) should be adapted.

11. The computing device (100, 200) according to claim 1, wherein said controller (210) is further configured to detect a speed (V) of the tracked object (H) and
determine whether the detected speed (V) is above a speed threshold and whether the movement is away from the display (120), and, if so, discontinue the tracking of the tracked object (H) and discontinue the indication of the operating area on the display (120).

12. The computing device (100, 200) according to claim 1, wherein said controller (210) is further configured to determine if the marker area (170) coincides, at least partially, with a displayed object (135) and if the distance (D1, D2) between the tracked object (H) and the display (120) is below a second threshold and if so display an option menu associated with the displayed object (135).

13. The computing device (100, 200) according to claim 1, wherein said computing device (100, 200) is a mobile communications terminal.

14. The computing device (100, 200) according to claim 1, wherein said computing device (100, 200) is a computer.

15. The computing device (100, 200) according to claim 1, wherein said computing device (100, 200) is a media device.

16. A method for use in a computing device (100, 200) comprising a display (120), said method comprising:
detecting and tracking an object (H) via a video stream (265) provided by camera (160, 260); and
indicating an operating area on the display (120) which is currently open for manipulation by the tracked object (H) by changing displaying properties of a marker area (170) on the display (120), wherein said displaying properties is the color, contrast and/or brightness of the marker area (170), and
wherein the marker area (170) has an extension (d1, d2) and
wherein said method further comprises detecting that the tracked object (H) is moved in a direction substantially perpendicular to the plane of the display (120) and in response thereto adapting the marker area (170), by further increasing the displaying properties of the marker area (170) and/or the extension (d1, d2) of the marker area (170), thereby providing visual feedback to a user of a current operating area.

17. A computer readable storage medium (40) encoded with instructions (41) that, when loaded and executed on a controller of a computing device (100, 200), causes the method according to claim 16 to be performed.

18. The computing device (100, 200) according to claim 2, wherein said controller (210) is further configured to adapt the marker area (170) increasingly as a distance (D1, D2) between the tracked object (H) and the display (120) is increased.

19. The computing device (100, 200) according to claim 3, wherein said controller (210) is further configured to adapt the marker area (170) increasingly as a distance (D1, D2) between the tracked object (H) and the display (120) is increased.

20. The computing device (100, 200) according to claim 4, wherein said controller (210) is further configured to adapt the marker area (170) increasingly as a distance (D1, D2) between the tracked object (H) and the display (120) is increased.
